(19) United States
(12) Patent Application Publication
(10) Pub. No.: US 2018/0272588 A1
(43) Pub. Date: Sep. 27, 2018

(54) Curved crease honeycombs with tailorable stiffness and dynamic properties

(71) Applicant: Massachusetts Institute of Technology, Cambridge, MA (US)

(72) Inventors: Samuel E. Calisch, Canbridge, MA (US); Neil A. Gershenfeld, Cambridge, MA (US)

(73) Assignee: Massachusetts Institute of Technology, Cambridge, MA (US)

(21) Appl. No.: 15/934,547

(22) Filed: Mar. 23, 2018

Related U.S. Application Data
(60) Provisional application No. 62/476,496, filed on Mar. 24, 2017.

(51) Int. Cl. B29C 47/00; B29D 99/00; B23P 15/24

(52) U.S. Cl. CPC B29C 47/0028; A43B 1/0009; B23P 15/243; B29D 99/0089

(57) ABSTRACT

Issues with pleat walled honeycombs are solved by replacing polygonal creases with curved creases. As with a conventional straight-walled honeycomb, these strips can be combined into a space-filling honeycomb structure. The benefits of these curved creases are threefold. First, the stress concentrations mentioned above with pleat-walled honeycombs are mitigated. The stress due to finite material thickness is spread more evenly over the crease line, instead of being concentrated at a point, as with pleat walled honeycombs. As a result, the maximal value observed is lower and the adverse effects are reduced. Second, the curved creases also serve to give better control over material properties, and third, the curved crease honeycombs do not require any of the horizontally-running creases. The curves are typically mathematical curves that can be computed algebraically or by solving a differential equation.

This application is related to, and claims priority from U.S. Provisional Patent Application No. 62/476,496 filed Mar. 24, 2017. Application No. 62/476,496 is hereby incorporated by reference in its entirety.

### BACKGROUND

### Field of the Invention

The present invention relates generally to pleat walled honeycomb structures used to provide tunable light-weight structurally strong members and more particularly to a class of curved crease honeycombs.

### Description of the Problem Solved

Application PCT/US2016/068765 shows methods to produce “pleat-walled” honeycombs with tailorable stiffness by adjusting a parameter of a two-dimensional folding pattern. In particular, by changing a pleat angle, the effective stiffness of the resulting honeycomb can be made to take on a range of values. When compressing pleat-walled honeycombs to large strains, significant stress concentrations can appear at the pleat vertices. FIG. 1A, shows a simulation of a honeycomb row under compressive load, where the color-map denotes stress. It is evident these vertices see significant stress. In practice, this can lead to plastic deformation, energy dissipation, and fatigue in applications. Secondarily, even though the stiffness can be tuned by pleat angle, the dynamic properties of these honeycombs are more difficult to control. This is because they are dominated by hinge stiffness and frictional boundary conditions. The former is difficult to control in manufacturing and can change significantly during the lifetime of a honeycomb. The latter depends sensitively on the manner loads are applied, which can vary during use. Finally, from a manufacturing viewpoint, the number of creases required by this approach is significantly larger than for straight-walled honeycombs. This results in significant effort necessary to scalably produce these structures.

### SUMMARY OF THE INVENTION

The present invention provides a solution to the three aforementioned issues with pleat walled honeycombs by replacing the polygonal creases with curved creases. In FIG. 1B, we show a row of a honeycomb structure with curved creases. As with a conventional straight-walled honeycomb, these strips can be combined into a space-filling honeycomb structure. The benefits of these curved creases are threefold. First, the stress concentrations mentioned above with pleat-walled honeycombs are mitigated. The stress due to finite material thickness is spread more evenly over the crease line, instead of being concentrated at a point, as with pleat walled honeycombs. As a result, the maximal value observed is lower and the adverse effects are reduced.

Second, the curved creases also serve to give better control over material properties. With pleated-wall honeycombs, the pleat angle alone determines the geometry, and hence the in-plane stiffness of the structure. With curved crease honeycombs, there are additional degrees of freedom in how the curve is parameterized. This is described in detail in “Parameterizations”. Besides just having additional degrees of design freedom, curved crease honeycombs exhibit two phenomena not present in pleat-walled honeycombs: 1) facet bending, 2) blocked states. Because facets bend, this can be used to store elastic energy, providing a more reliable source of stiffness than the hinge stiffness alone. The blocked states of curved crease honeycombs allow tailoring of the large deformation behavior of the honeycomb. For instance, one can specify a desired initial stiffness which then increases after a prescribed amount of strain. This is described in detail in “Material Properties”.

Third, the curved crease honeycombs do not require any of the horizontally-running creases seen in FIG. 1A. Because of this, they have the same number of creases as simple straight-walled honeycombs, a significant advantage for efficient manufacturing over pleat-walled honeycombs. In “Manufacturing”, several approaches are described to fabricate curved crease honeycombs leveraging this advantage.

With these advantages of the present invention over pleat-walled honeycombs, many of their advantages can still be applied. For instance, by controlling the location of cuts and folds in two-dimensions, the three-dimensional shape can be specified. This eliminates the need for external molds or post-machining in a number of applications, and allows for great manufacturing flexibility, on-demand production, and lower overall cost and energy inputs.

### DESCRIPTION OF THE FIGURES

Attention is not directed to several figures that illustrate features of the present invention.

FIGS. 1A, 1B. A) Stress concentration at vertices of pleated honeycomb B) Row of curved crease honeycomb

FIGS. 2A, 2B, 2C. Biarc parameterization of curved creases. A) 30° with respect to vertical for a range of arc radii, B) 45° with respect to vertical for a range of arc radii C) Calculating bi-arc ratios.

FIGS. 3A, 3B, 3C, 3D: Changing biarc parameterization to change mechanics. A) Straight-walled honeycomb, B) Curved crease honeycomb, C) Large pleat angle, large arc radius, D) Large pleat angle, small arc radius.

FIGS. 4A, 4B, 4C: A-C) Elastica shapes of a loaded facet, D) Elastica parameterization of curved creases

FIGS. 5A, 5B, 5C, 5D: Energy absorption of curved crease honeycomb (A,B) compared to straight-walled honeycomb (C,D).

FIGS. 6A, 6B, 6C, 6D: Energy return of carbon fiber reinforced curved crease honeycomb, A) pre-impact, B) max deformation, C) post-impact.

FIGS. 7A, 7B, 7C, 7D, 7E, 7F, 7G, 7H, 7I: Expansion Fabrication. A) Layer diagram for biased honeycomb, B-G) Laser cut 1095 steel layers are stacked with Kapton hinges bonded by Dupont Pyralux LF and then baked under pressure. H) Cured sample, ready for expansion. I) Sample expanded after shearing layers.

FIGS. 8A, 8B, 8C, 8D, 8E: Creased and Stacked fabrication. A) Aluminum curved crease honeycombs showing three different crease curves, B) Sheets after creasing, C) Sheets stacked for gluing, D-E) Dynamic steel rule die showing two configurations.

FIGS. 9A, 9B, 9C, 9D, 9E, 9F, 9G, 9H, 9I: Composite-Polymer lamination fabrication. A) Oscillating knife cutting pre-impregnated fiber, B) Curing the fiber between polymer layers (top polymer layer not shown), C) Post-cure view of hinge, D), Post-cure cross section, showing layup schedule and polymer layers, E) Post-cure view of actuated hinge, F) Post-curve view of full sheet, G) After cutting strips free from panel, H) Folded strips ready for stacking and gluing, I) Finished composite curved crease honeycomb.

Several drawings and illustrations have been presented to aid in understanding the present invention. The scope of the present invention is not limited to what is depicted in the figures.

### DESCRIPTION OF THE PREFERRED EMBODIMENTS

### Parameterizations

In generalizing from pleated-wall honeycombs to curved crease honeycombs, one must choose which curves to use for the creases. While nearly any periodic curve will work (e.g. a sine function); the preferred primarily parameterizations of the present invention are biarc and elastica curves.

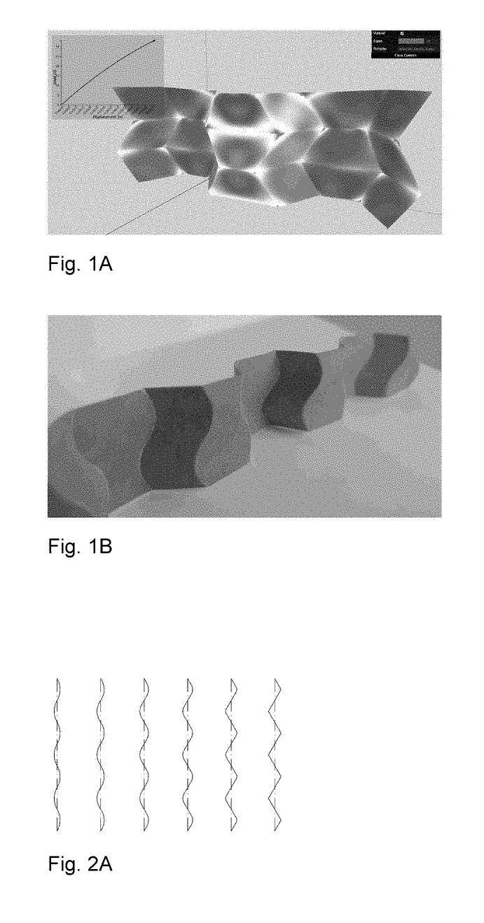

FIG. 1A shows stress concentration at vertices of pleated honeycomb. FIG. 1B shows a row of curved crease honeycomb.

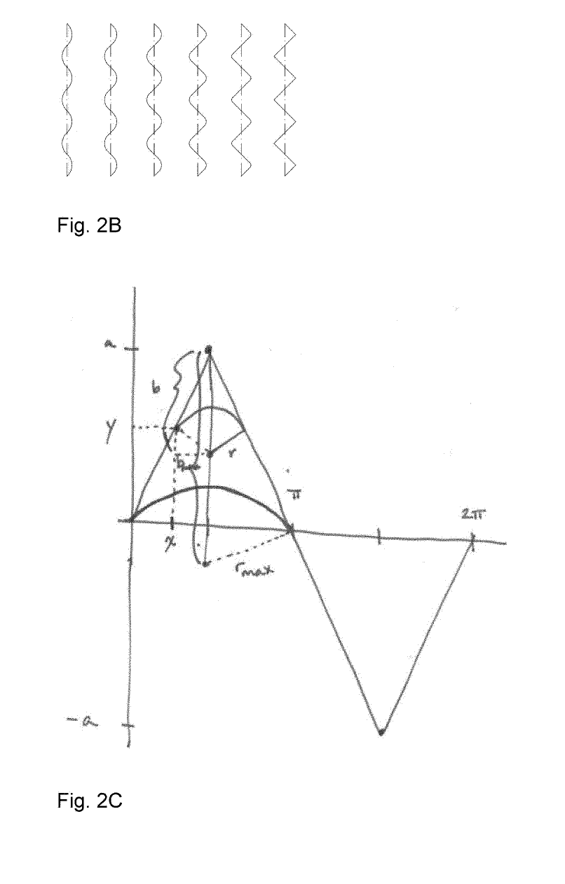

Biarcs are piecewise-defined alternating lines and arcs such that consecutive sections are mutually tangent. Several examples are shown in FIG. 2. This parameterization naturally generalizes pleated-wall honeycombs since zig-zag creases are just a limiting case of a biarc as the joining arc radius goes to zero. As such, one can still use the pleat angle as one parameter of the biarc curve. The other necessary parameter describes the size of the joining arc radius. For a given period and pleat angle, there is a maximum possible joining arc radius, so this value is used to normalize the arc fraction parameter between 0 (no arc) and 1 (maximum radius arc). FIGS. 2 A and B show biarc curves for pleat angles of 30 and 45 degrees respectively for a range of arc fractions.

To calculate the geometry arising from this biarc parameterization, it is first noted that for period 2 π and pleat angle α, the amplitude a corresponding to a curve with zero arc fraction is (π/2)/tan(α). FIG. 2C depicts these quantities. The maximum possible arc radius is rₘₐₓ=(π/2)\sqrt{π²/4a²+1}. For a given arc radius r, the goal is to derive expressions for x and y (the coordinates of the transition from line segment to arc) as well as b, the vertical distance from a to the center of the arc. b must lie between zero and bₘₐₓ=a+π²/(4a). Using similar triangles, one has b=bₘₐₓr/rₘₐₓ. Then, finally:

x=π/(2a)(a−b+π²/(4a))/(π²/4a²+1)

and

y=a−b+π/(2a)(π/2−x).

These transition coordinates can be used to define a piecewise function for the biarc curve. For instance, the arc segment is given by

y(x)=a−b+\sqrt{r²−(π/2−x)²}

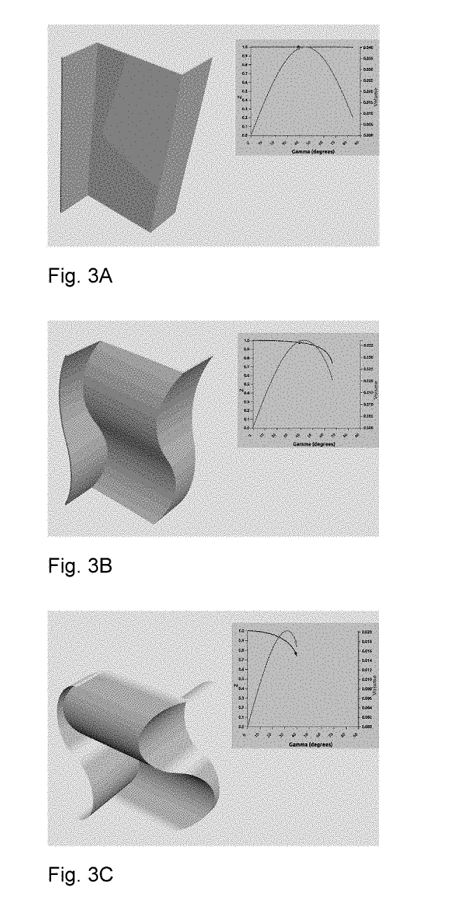

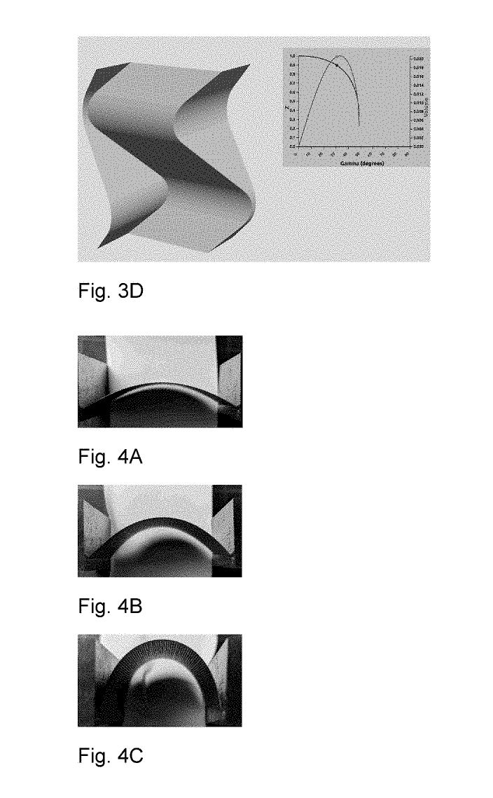

Using these expressions, one can calculate the geometry of biarc-based curved crease honeycombs. In FIG. 3, several such honeycombs are shown, along with their folding mechanisms. FIG. 3 shows a straight-walled honeycomb, a curved crease honeycomb, a curved crease honeycomb with large pleat angle, and finally a curved crease honeycomb with large pleat angle but small arc fraction.

The second crease curve parameterization used is given by elastica curves, or the shape made by an elastic beam subject to an end load. The advantage to this parameterization is that the curved creases enforce a shape very similar to the natural shape of the bent facets under compressive loading. This lowers the stress seen by the crease and extends its lifetime. Timoshenko (Theory of Elastic Stability, pp 76-) shows how to derive expressions for total deflection of the beam ends using elliptic integrals. The full shapes can be calculated in closed form using incomplete elliptic integrals, or we can use numerical integration of the governing differential equation:

∂²θ/∂s²=−(P/EI)sin(θ)

Where E is the material elastic modulus, I is the second area moment of inertia, s is the length measured along the beam, P is a force, and θ is the angle made by the beam with respect to the vertical. This equation is simply a statement that bending moment equals flexural rigidity times the curvature. This formulation can also be parameterized by effective pleat angle α made by the crease line at its end with respect to the vertical with the substitution

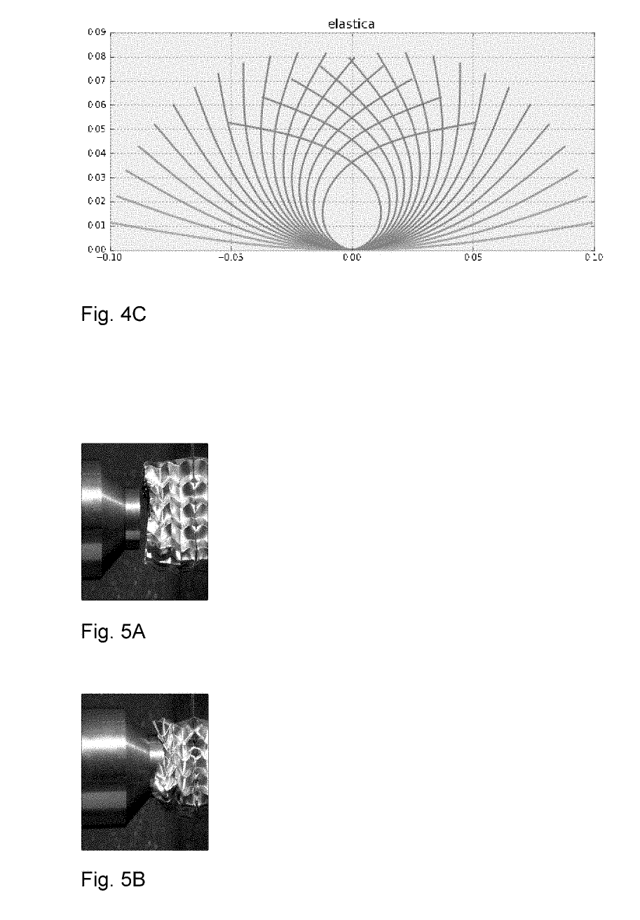

P=(EI/l²)K(sin(α/2))

Where K denotes the complete elliptic integral of the first kind and l denotes the length of the beam. FIGS. 4 A-C, shows a bent facet exhibiting the elastica curve shape. FIG. 4D shows the calculated curve shapes parameterized by pleat angle.

### Material Properties

The parameterizations described above can be used to tailor the material properties of the resulting curved crease honeycombs.

The initial stiffness (stiffness at low strains) is largely a dependent on the relationship between height of the honeycomb and the bending of its facets. The flexural rigidity of each facet resists this bending, and hence the honeycomb itself becomes a spring. More specifically, the force exerted by the honeycomb in the direction of compression (z) is equal to minus the derivative of stored elastic energy with respect to z. This elastic energy for each facet is proportional to the integral over the facet of curvature squared. The facet curvature is a direct function of crease curvature and fold angle. Hence, the stiffness of the honeycomb is a function not only of the value of curvature of the crease, but the distribution of curvature over the crease. Hence, stiffness can be controlled by tuning this parameters.

Secondary stiffness (stiffness at large strains) can be controlled by utilizing the curved crease honeycomb's blocked state, that is, the state after which no further folding mechanism is possible due to geometric constraints. In FIG. 3, these blocked states are shown as the graphed curves of geometric mechanisms are truncated. Parameterizations with a large arc fraction exhibit a blocked state earlier (with respect to z) than those with smaller arc fractions. After a honeycomb hits the blocked state, any further elastic deformation is a function of deformations of creases or stretching of facets. Generally, these deformations have much higher stiffness than the folding mechanism of the curved crease honeycomb, and so the blocked state can be used to set a high secondary stiffness. This is especially useful to create honeycombs that are relatively soft to small deformations, but exhibit high stiffness at larger deformations.

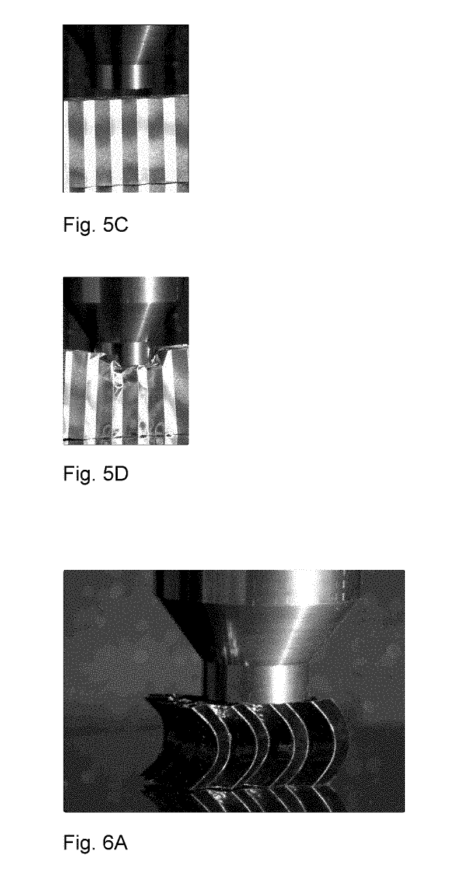

These tunable properties of curved crease honeycombs can be used to set dynamic, as well as static properties. FIG. 5 shows a curved crease and straight-walled honeycomb absorbing the energy of an impact. Straight walled honeycombs are commonly used in crash panels and other applications where plastic deformation is used to absorb energy while minimizing transferred force. Curved crease honeycombs offer several advantages in these applications. First, for a given volume, more material participates in the plastic deformation of a crushed curved crease honeycomb as a crushed straight walled honeycomb. Because of this, there is simply more opportunity to do plastic work and hence extract energy. Second, the negative Poisson ratio of the curved crease honeycombs draws more material from the surrounding honeycomb into the site of an impact, which further amplifies this advantage over straight-walled honeycombs. Finally, because the curved crease honeycomb has a designed buckling pattern, it can be made to collapse in a space-efficient manner, increasing the crushing distance over which energy can be extracted. Straight-walled honeycombs can crush in a disordered way, making poor use of the available crushing distance.

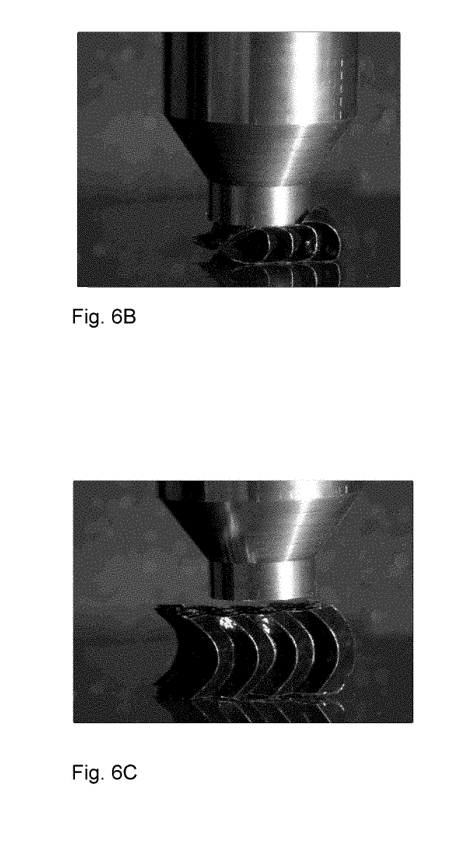

Conversely, curved crease honeycombs can also be made to return energy efficiently upon compaction. FIG. 6 shows a curved crease honeycomb under a traveling mass before, during, and after impact. The honeycomb is designed to have a low initial stiffness to softly catch the mass, with a high secondary stiffness to absorb and return the kinetic energy of the mass. FIG. 6B shows the curved crease honeycomb at maximum deformation, in its blocked state. FIG. 6C shows the curved crease honeycomb after full rebound and transfer of kinetic energy back to the mass. Such curved crease honeycombs may be used in applications requiring lightweight, manufacturable dynamic structures with good energy return, such as athletic shoes.

### Manufacturing

Due to the reduced number of creases as compared to pleated-wall honeycombs, curved crease honeycombs can be manufactured more efficiently. Three methods are discribed, though many other are possible.

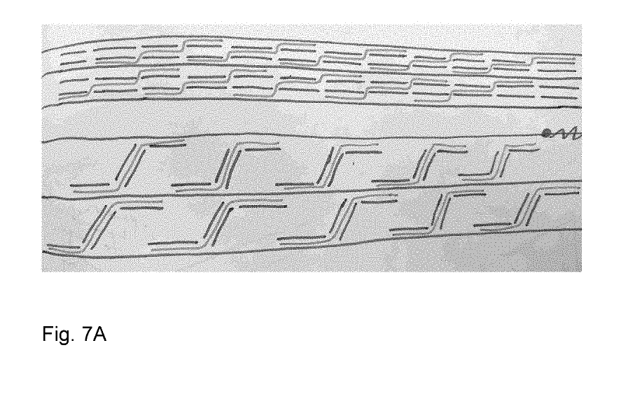

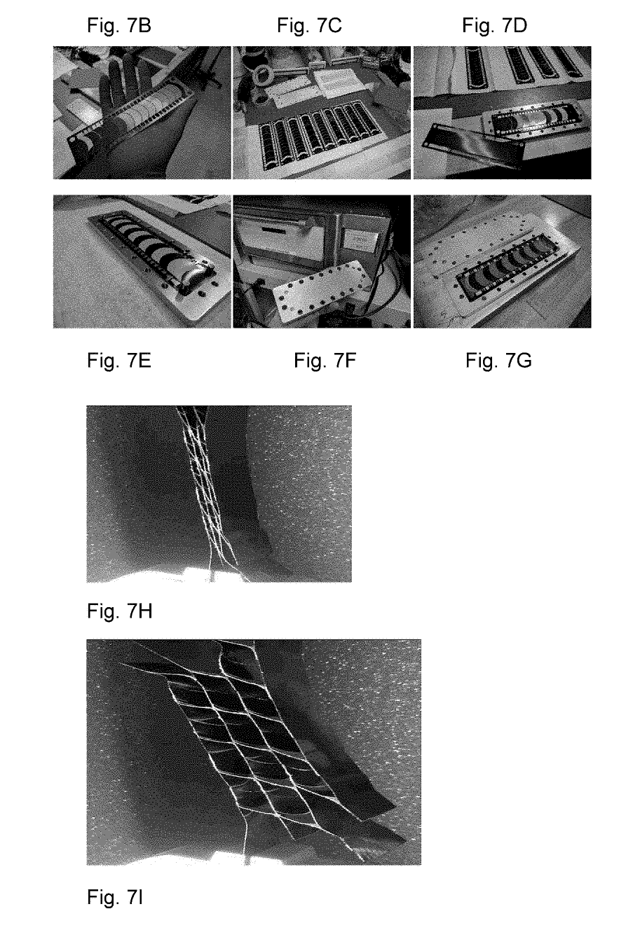

First a method inspired by the “expansion” fabrication of straight-walled honeycombs is shown where many flat sheets are selectively glued or welded along evenly spaced lines with parity that alternates with each sheet. When the sheets are pulled apart (i.e., expanded), the honeycomb creases are formed as the sheet material is pulled taut between the bond lines. A similar method can be used with curved crease honeycombs, where instead of straight bond lines, the bonding is along the curved crease lines. When expanded, the curved creases are actuated in parallel, effectively folding many at once. This method works well if crease curvature is relatively small, but larger curvature is problematic due to the bistable singularity of the curved crease in its flat state. For larger crease curvature, however, one can modify the above expansion fabrication method as shown in FIG. 7. Here, instead of expanding the honeycomb in the normal direction of the sheets, the honeycomb is biased so shearing two consecutive layers will cause them to pop-up into three dimensions, actuating all curved crease lines on that layer. The stack-up of layers provides a small initial bias to start the pop-up motion. In FIG. 7, a two-material system is shown, where 1095 steel (0.002″ thickness) forms the facets, Kapton polymer (0.001″) forms the hinges, and Dupont Pyralux LF acrylic adhesive bonds the layers together. This method can also work with single material systems.

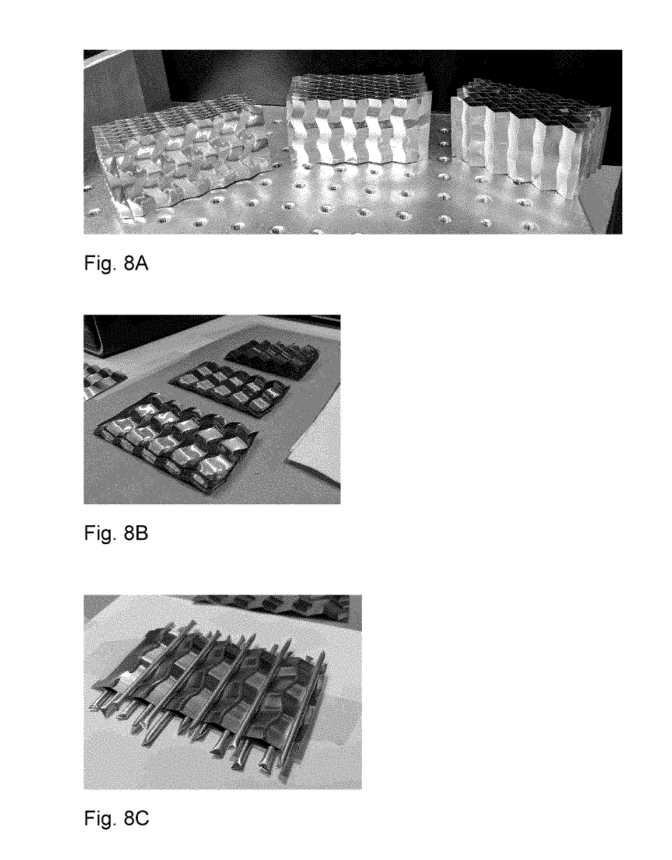

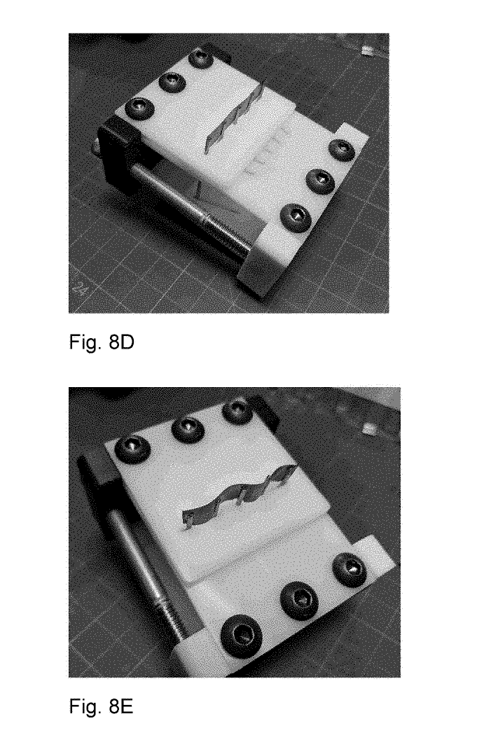

Second, a manufacturing method inspired by the method of fabricating straight-walled honeycombs is shown consisting of corrugating, stacking, and selectively bonding sheets. Instead of corrugating, however, a steel rule die is used, which creases sheets when used to press them into an elastomer substrate and can accommodate a variety of curved crease shapes. These creased sheets are then stacked and bonded to form a honeycomb. A version of this method is shown in FIG. 8 using hardened 1100 series aluminum foil (0.003″ thickness). The sheets are creased by a dynamic steel rule die, which can change the curvature of the crease subject to turning a screw. Using this dynamic die, the crease curve (and hence the honeycomb properties) can be quickly varied during fabrication.

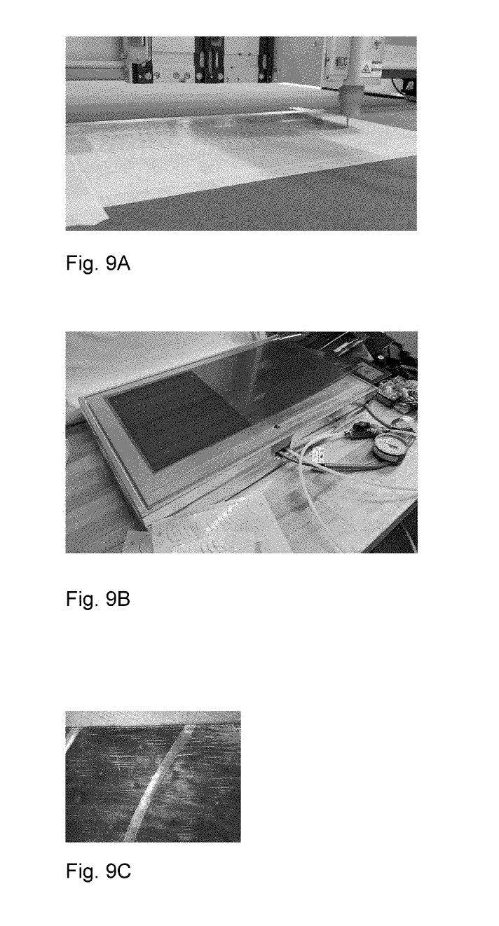

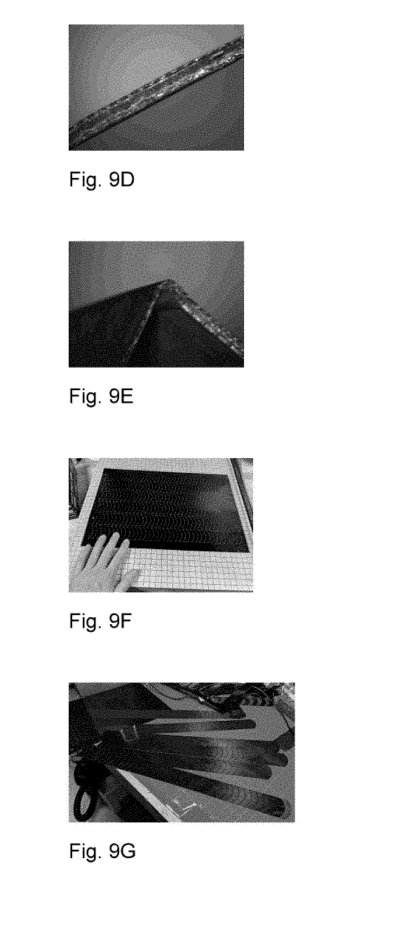

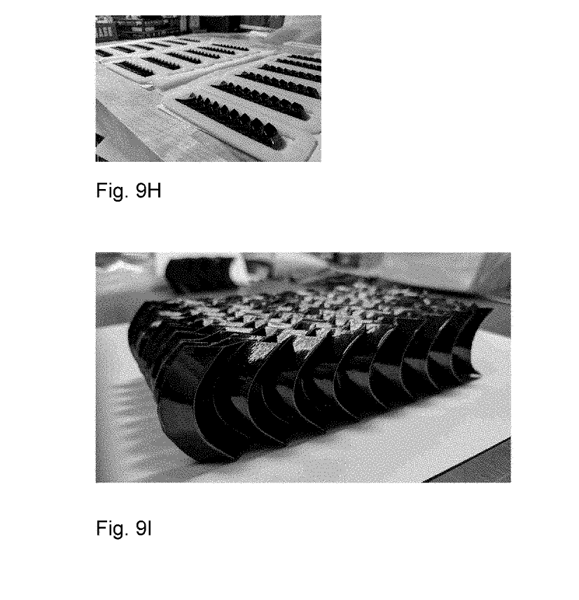

Third, a manufacturing method amenable to composite materials like carbon fiber reinforced polymer is shown. While this method was specifically developed for composite materials, it also works with metal, polymer, or other more conventional base materials. In this method, we use an oscillating knife to cut a stack of pre-impregnated fiber, arranged according to a prescribed layup schedule. In FIG. 9, a 0-90-0 layup of 15, 130, and 15 grams per square meter, respectively is shown. The oscillating knife cuts away a narrow strip of the fiber along each curved crease. The pre-impregnated fiber is then cured between two sheets of high temperature polymer under vacuum. FIG. 9 shows Kapton (0.002″ thickness), but this can be replaced by a variety of plastics, including Nylon, PET, PEI, or PEEK. After curing, the void left by the cutaways forms a curved crease between the adjacent fiber reinforced panels. The sheet can be recut with the oscillating knife to free the strips from the surrounding panel. These strips can then be folded, stacked, and bonded to form a curved crease honeycomb.

Several descriptions and illustrations have been presented to aid in understanding the present invention. One with skill in the art will realize that numerous changes and variations may be made maintaining the spirit of the invention and are within the scope of the present invention.

We claim:

1. A honeycomb structure comprising:
a plurality of 3-dimensional structural honeycombs formed from a cut and folded substrate sheet that has a regular pattern of cut areas and creases, each of said creases being a curved crease following a predefined mathematical curve, the plurality of honeycombs each having identical cells; each cell having at least one pleat angle, and each cell having at least one face abutting at least one face of another cell;
at least one join between some abutting faces of the structure that stabilizes the structure into a fixed shape.

2. The honeycomb structure of claim 1 wherein the mathematical curve is a biarc.

3. The honeycomb structure of claim 2 wherein the biarc has a center and is defined by a pleat angle a and a vertical distance b from a to the center wherein the maximum possible arc radius is rₘₐₓ=(π/2)\sqrt{π²/4a²+1}
and x and y coordinates of a transition from line segment to arc are defined by
x=π/(2a)(a−b+π²/(4a))/(π²/4a²+1);
y=a−b+π/(2a)(π/2−x)
and an arc segment is defined by:
y(x)=a−b+\sqrt{r²−(π/2−x)²}

4. The honeycomb structure of claim 1 wherein the mathematical curve is an elastica curve.

5. The honeycomb structure of claim 4 wherein the elastica curve is defined by the pleat angle α and
P=(EI/l²)K(sin(α/2))
where K is a complete elliptic integral of the first kind, l is a beam length, E is the material elastic modulus, I is the second area moment of inertia, and P is a force.

6. The honeycomb structure of claim 4 wherein the elastica curve is defined by a differential equation, and the curve is computed by numerical integration of the differential equation.

7. The honeycomb structure of claim 6 wherein the differential equation is:
∂²θ/∂s²=−(P/EI)sin(θ)
where E is the material elastic modulus, I is the second area moment of inertia, s is the length measured along a beam, P is a force, and θ is the angle made by the beam with respect to the vertical.

8. The honeycomb structure of claim 1 wherein each honeycomb is a volume-filling structure.

9. The honeycomb structure of claim 1 wherein at least one of top or bottom of the honeycomb forms a 2-dimensional shape along its length.

10. The honeycomb structure of claim 1 wherein the join is glue or spot welding.

11. The honeycomb structure of claim 1 wherein the join is a skin covering at least part of the structure.

12. A honeycomb structure comprising a plurality of 3-dimensional honeycombs, wherein each of said honeycombs has at least one curved crease.

13. The honeycomb structure of claim 12 wherein the curved crease is defined by a mathematical curve.

14. The honeycomb structure of claim 13 wherein the mathematical curve is a biarc.

15. The honeycomb structure of claim 13 wherein the mathematical curve is an elastica curve.

16. A method of fabricating a curved crease honeycomb structure comprising:
gluing or welding a plurality of flat sheets with selectively evenly spaced curves with parity that alternates with each sheet;
pulling the sheets apart causing curved honeycomb creases to be formed as the sheet material is pulled taut between the bond lines.

17. The method of claim 16 wherein, when expanded, the curved honeycomb creases are actuated in parallel as the sheets are pulled apart effectively folding many at once.

18. The method of claim 16, wherein the curves are mathematical curves.

19. The method of claim 18, wherein the curves are biarcs.

20. The method of claim 18 wherein the curves are elastica curves.
